(19) United States
(12) Patent Application Publication
(10) Pub. No.: US 2015/0075476 A1
(43) Pub. Date: Mar. 19, 2015

(54) FOUR-CYCLE ENGINE AND ENGINE GENERATOR

(71) Applicant: YAMAHA MOTOR POWER PRODUCTS KABUSHIKI KAISHA, Kakegawa-shi (JP)

(72) Inventor: Atsushi SUZUKI, Shizuoka (JP)

(21) Appl. No.: 14/484,473

(22) Filed: Sep. 12, 2014

(30) Foreign Application Priority Data
Sep. 13, 2013 (JP) 2013-191202

(51) Int. Cl. F01L 13/00; F02B 75/02; F02N 3/02; F02B 63/04

(52) U.S. Cl. CPC F01L 13/00; F02B 63/044; F02B 75/02; F02N 3/02; F02B 2075/027
USPC 123/185.1

(57) ABSTRACT

An engine generator includes a four-cycle engine including a cylinder, one inlet port that supplies air-fuel mixture into the cylinder, one inlet valve that opens/closes the inlet port, a piston reciprocable inside the cylinder, a crank shaft that converts reciprocating movement of the piston into rotating movement, a connecting rod that connects the piston and the crank shaft to each other, and a recoil starter that rotates the crank shaft. The engine has a geometric compression ratio not smaller than about 8.5. The valve closure timing of the inlet valve is defined as a timing when the closing inlet valve has a valve lift of about 1 mm, and is within a range from after the bottom dead center to the top dead center.

### BACKGROUND OF THE INVENTION

1. Field of the Invention

The present invention relates to four-cycle engines and engine generators. More specifically, the present invention relates to a four-cycle engine including a manual starter, and to a generator driven thereby.

2. Description of the Related Art

It is generally known that in order to improve engine thermal efficiency, increasing a compression ratio (expansion ratio) in the combustion chamber is effective. Increasing the compression ratio, however, will increase pressure in the compression step, resulting in an increased cranking torque required when starting the engine. Engines provided with manual starters are sometimes equipped with de-compressors as disclosed in JP-A S60-156976, for releasing the compression pressure to help human operators who would otherwise have to be more powerful to overcome the increased cranking torque when starting the engine.

However, opening the engine exhaust valve during the compression step when starting the engine to let the introduced air-fuel mixture escape to the exhaust pipe means that the unburned air-fuel mixture is supplied to the exhaust system, leading to occasional after fire.

### SUMMARY OF THE INVENTION

Therefore, preferred embodiments of the present invention provide a four-cycle engine which has a high geometric compression ratio yet does not require as much cranking torque when starting the engine and is capable of reducing after fire, and also provide a generator driven by the engine.

According to an aspect of various preferred embodiments of the present invention, a four-cycle engine includes a cylinder; one inlet port configured to supply an air-fuel mixture into the cylinder; one inlet valve configured to open and close the inlet port; a piston reciprocable inside the cylinder; a crank shaft configured to convert reciprocating movement of the piston into rotating movement; a connecting rod configured to connect the piston and the crank shaft to each other; and a manual starter configured to rotate the crank shaft. The engine preferably has a geometric compression ratio not smaller than about 8.5, for example and the inlet valve has a valve closure timing selected from a range from after a bottom dead center to a top dead center, wherein the inlet valve closure timing is defined as a moment when the inlet valve in its closing stroke has a valve lift of about 1 mm, for example.

According to various preferred embodiments of the present invention, the inlet valve is open even after the bottom dead center and therefore, the air-fuel mixture which was once introduced into a combustion chamber of the cylinder is pushed back to an upstream of the inlet valve (toward the intake pipe). For this reason, even if the geometric compression ratio is high, being not smaller than about 8.5, an actual compression ratio is lower than the geometric compression ratio. Consequently, the actual compression pressure is not as high as a compression pressure under the geometric compression ratio. In other words, the engine provides a high expansion ratio but the actual compression pressure does not become high. This makes it possible to significantly reduce or prevent an increase in engine starting cranking torque necessary from the manual starter while improving thermal efficiency of the engine. Also, since the air-fuel mixture is not released to the exhaust pipe but to the intake pipe, the arrangement reduces after fire. As understood, the arrangement makes it possible, while keeping a high geometric compression ratio, to significantly reduce or prevent an increase in the engine starting cranking torque, and to significantly reduce or prevent after fire as well.

Preferably, the four-cycle engine is provided by a single-cylinder engine. Compared to a multi-cylinder engine, a single-cylinder engine has a smaller friction loss if the engine displacement is the same, because a single-cylinder engine has a smaller sliding surface area between the piston and the cylinder. Also, a single-cylinder engine has a smaller total surface area of the cylinder and the combustion chamber. Therefore, the single-cylinder engine has a smaller thermal loss and a higher thermal efficiency. In addition, it is often the case that a single-cylinder engine includes a manual starter. Since various preferred embodiments of the present invention make it possible to significantly reduce or prevent an increase in the engine starting cranking torque even if the geometric compression ratio is high, preferred embodiments of the present invention are suitable for a single-cylinder engine.

Further preferably, the valve closure timing of the inlet valve is selected from a range of not smaller than about 43 degrees to not greater than about 74 degrees, for example, in terms of a crank angle from the bottom dead center. In this case, the arrangement makes it possible to appropriately reduce the actual compression ratio, and therefore to significantly reduce or prevent an increase of engine starting cranking torque while improving thermal efficiency of the engine.

Further, preferably, the four-cycle engine is provided by a gas-fuel engine which utilizes a gaseous fuel. Gaseous fuels such as a fuel gas typically have smaller Lower Heating Values, and therefore tend to produce lower output than liquid fuels such as gasoline if engine displacement is the same. For improved output, increasing the compression ratio is a key, but like in liquid-fuel engines, this often leads to a problem of abnormal combustion, like knocking. Since preferred embodiments of the present invention make it possible to maintain a high output while reducing abnormal combustion, preferred embodiments of the present invention are suitably applicable to gas-fuel engines.

Further, preferably, the four-cycle engine according to a preferred embodiment of the present invention is utilized in an engine generator. Typically, an engine generator uses its engine at 3000 rpm through 3600 rpm in normal power generation operation. If an actual compression ratio is high, then it becomes likely to see knocking in a medium-low rotation region of the engine before a normal, high rotation region is reached. A conventional attempt to this problem is, for example, to have two inlet valves in the engine, and control valve opening/closure timings of the two inlet valves independently from each other in accordance with the number of engine revolutions using a variable valve mechanism, thus adjusting the actual compression ratio to reduce knocking. In this case, however, complicated control must be provided and a number of engine parts must be increased, leading to increased cost and difficulty of manufacture. The engine generator may be equipped with a governor which controls the number of engine revolutions. Even in this case, however, the number of engine revolutions can drop into the medium-low rotation region and knocking can happen if the generator comes under a load fluctuation.

To solve these problems, the inventor of preferred embodiments of the present invention developed an arrangement involving a so called Atkinson cycle in which a valve closure timing of an inlet valve is after the bottom dead center, in an engine which includes a single inlet valve, paying special attention to a fact that the amount of air-fuel mixture which is pushed back to an upstream of the inlet valve varies when the number of revolutions of the engine varies. Specifically, as the number of revolutions of the engine becomes higher, fluid velocity of the air-fuel mixture becomes higher, and therefore there is a higher resistance to reversing of the flow of the air-fuel mixture to the upstream of the inlet valve. Simultaneously, the period from the time when the piston is at the bottom dead center to the time when the inlet valve is closed becomes shorter, so the air-fuel mixture becomes less prone to flow upstream of the inlet valve. This means that the actual compression ratio in a medium-low rotation region can be made smaller than in a high rotation region, and that the actual compression ratio in the high rotation region does not decrease as much. Hence, if the engine according to various preferred embodiments of the present invention, including a single inlet valve, is utilized in an engine generator, it is possible to reduce knocking in a medium-low rotation region while reducing cost of manufacture, and it is possible to obtain good thermal efficiency and output in a high rotation region (range of normal engine use) of 3000 rpm through 3600 rpm. Therefore, the four-cycle engine according to various preferred embodiments of the present invention can be suitably utilized for engine generators.

It should be noted here that the valve closure timing of the inlet valve is preferably defined as a moment when the inlet valve in its closing stroke has a valve lift of about 1 mm, for example. This is because it is difficult to accurately identify a crank angle when the valve lift is closer to 0 mm where the inlet valve is completely closed, since the amount of change in the valve lift becomes smaller as the valve lift becomes closer to 0 mm.

It should also be noted here that the geometric compression ratio refers to a ratio between a volume inside the cylinder when the piston is at the bottom dead center and a volume inside the cylinder when the piston is at the top dead center.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view from a front left view point, of an engine generator which includes a four-cycle engine according to a preferred embodiment of the present invention.

FIG. 2 is a perspective view from a rear right view point, of the engine generator which includes the four-cycle engine according to a preferred embodiment of the present invention.

FIG. 3 is an illustrative drawing, showing a longitudinal section of the four-cycle engine.

FIG. 4 is an illustrative drawing of a section taken in lines B-B in FIG. 3, showing an interior with cut surfaces of a cylinder head cover, a cylinder head, a cylinder body and a crank case.

FIG. 5 is an illustrative drawing, showing valve opening/closure timings, etc. of an inlet valve.

FIG. 6A and FIG. 6B are illustrative drawings, showing air-fuel mixture flowing into/out of a combustion chamber.

FIG. 7 is a graph, showing a relationship between a crank angle and a valve lift in an inlet valve and an exhaust valve.

FIG. 8A is an illustrative drawing, showing periods and valve opening/closure timings of an inlet valve shown in Table 1, whereas FIG. 8B is an illustrative drawing, showing periods and valve opening/closure timings of an exhaust valve shown in Table 1.

FIG. 9 is a graph, showing a relationship between the number of revolutions of the engine and an amount of air introduced.

FIG. 10 is a graph, showing a relationship between the number of revolutions of the engine and engine torque.

FIG. 11 is a graph, showing a relationship between the number of revolutions of the engine and fuel consumption rate.

### DETAILED DESCRIPTION OF THE PREFERRED EMBODIMENTS

Hereinafter, preferred embodiments of the present invention will be described with reference to the drawings.

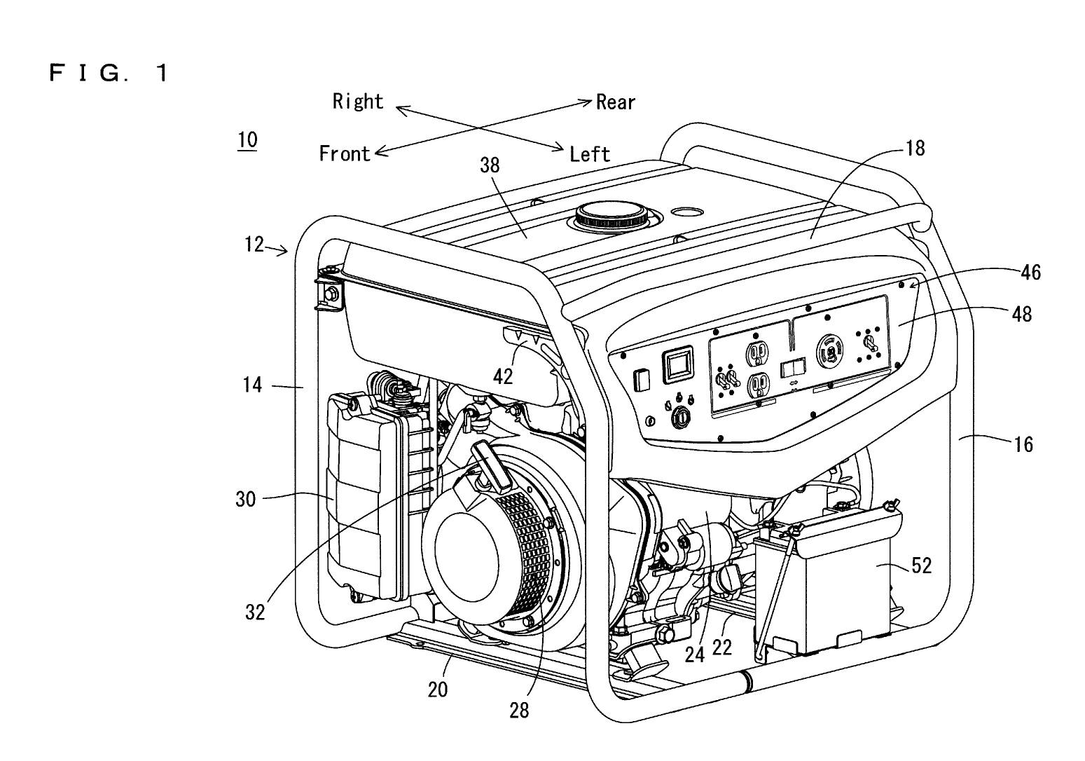

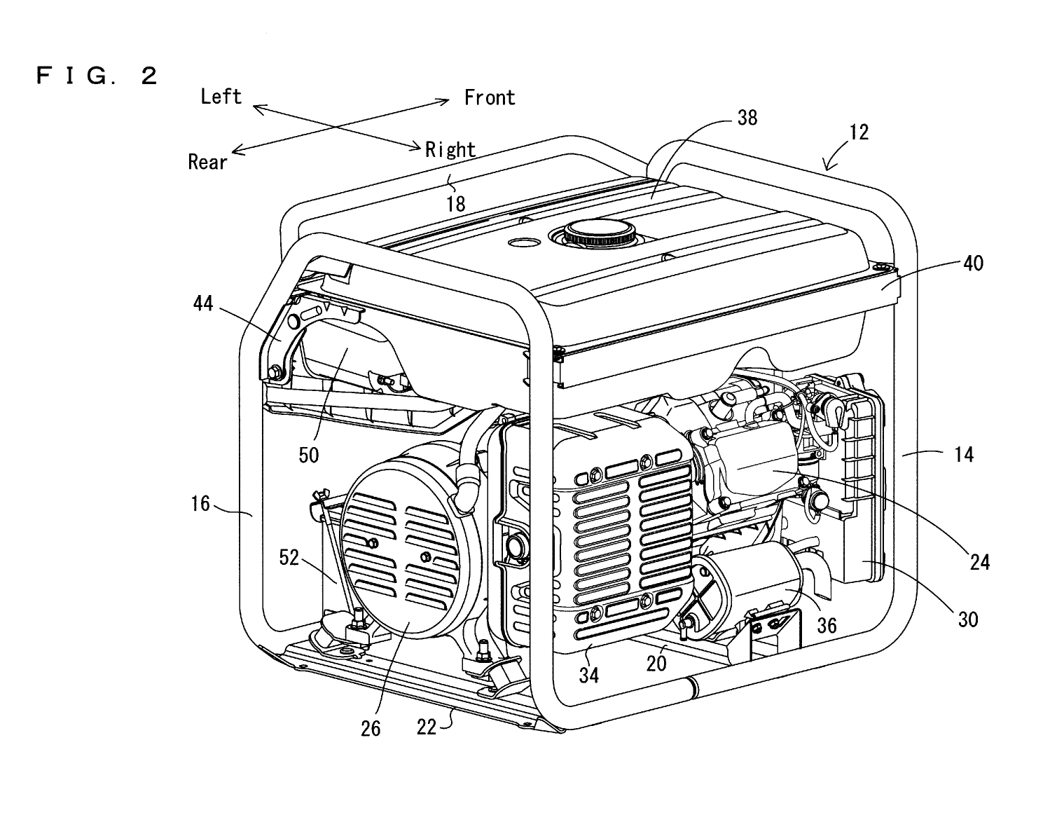

FIG. 1 and FIG. 2 show an engine generator 10 which includes a four-cycle engine (hereinafter, will be called “engine”) 24 (to be described later) according to a preferred embodiment of the present invention. In the present specification, a “fore-aft direction” and a “left-right direction” in the engine generator 10 are defined as shown in FIG. 1 and FIG. 2 for the sake of descriptive convenience. Thus, a side on which the engine 24 is provided is a “front side”, a side on which a generator 26 (to be described later) is provided is a “rear side”, and a side on which an operation panel 48 (to be described later) is provided is a “left side”.

The engine generator 10 preferably is a portable generator, including a generator frame 12. The generator frame 12 includes a front frame 14, a rear frame 16, an upper frame 18, and a pair of lower frames 20, 22. The front frame 14 is provided by a pipe-shaped member which is preferably formed into a general shape of inverted letter of U in a front view, whereas the rear frame 16 is provided by a pipe-shaped member which is preferably formed into a general shape of inverted letter of U in a rear view. The front frame 14 and the rear frame 16 are connected with each other at both of their end portions. The upper frame 18 is provided by a pipe-shaped member and extends in the fore-aft direction, connecting upper left end portions of the front frame 14 and the rear frame 16 respectively. The upper frame 18 defines and serves as a grip. The lower frame 20 is a platy member extending in the left-right direction, connecting left and right lower portions of the front frame 14 with each other. The lower frame 22 is a platy member extending in the left-right direction, connecting left and right lower portions of the rear frame 16 with each other.

The engine 24 is installed on the lower frame 20, whereas the generator 26 is installed on the lower frame 22. The engine 24 and the generator 26 are arranged in the fore-aft direction, with the engine 24 being on the front side and the generator 26 being on the rear side. The engine 24 includes a crank shaft 66 (to be described later), which is connected with a rotating shaft (not illustrated) of the generator 26.

The engine 24 includes, on its front side, an air intake section 28 to introduce outside air. The air intake section 28 includes a cooling fan (not illustrated). An air cleaner 30 is provided on the right side of the air intake section 28. As the cooling fan is driven, outside air introduced from the air intake section 28 cools the engine 24. A recoil starter 32 defining and serving as a manual starter is provided near the air intake section 28.

A muffler 34 is provided behind the engine 24, on the right side of the generator 26. Exhaust gas from the engine 24 is discharged to outside via the muffler 34. A canister 36 is provided below the engine 24. A fuel tank 38 is connected to the air cleaner 30 via the canister 36. Gasoline vapor from the fuel tank 38 is adsorbed in the canister 36.

The fuel tank 38 is arranged to cover the engine 24 and the generator 26 from above. The fuel tank 38 stores gasoline as a fuel to be supplied to the engine 24. The fuel tank 38 has its right side portion attached to a support frame 40 which connects an upper right end portion of the front frame 14 and an upper right end portion of the rear frame 16 to each other. The fuel tank 38 has its left front portion and left rear portion connected to the front frame 14 and the rear frame 16 respectively via brackets 42 and 44.

An operation box 46 is provided on the left side of the fuel tank 38. The operation box 46 includes the operation panel 48, and a case 50 which is provided on the right side of the operation panel 48 and incorporates an operation section (not illustrated), etc. A battery 52 is provided below the case 50.

In the engine generator 10 described as above, the recoil starter 32 is pulled to rotate the crank shaft 66 and start the engine 24. As the engine 24 starts, the generator 26 starts its power generating operation. The electric power from the generator 26 is taken out of the operation panel 48 or stored in the battery 52.

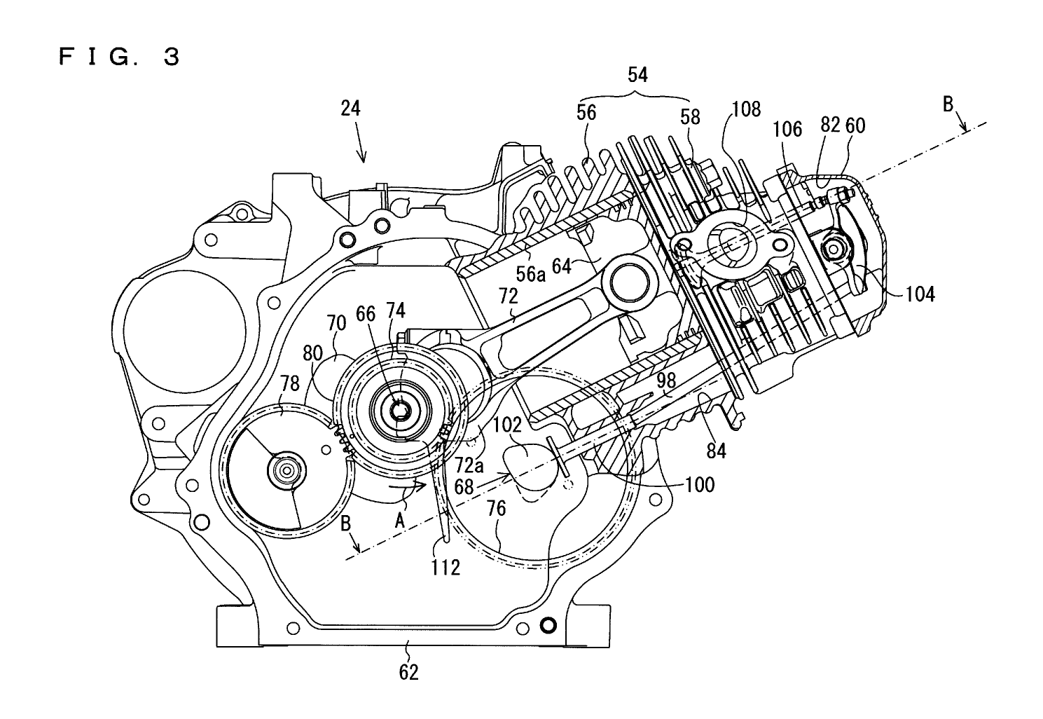

Reference will now be made to FIG. 3 to describe the engine 24.

The engine 24 preferably is, for example, an air-cooled, single-cylinder, four-cycle, slanted-type OHV engine (Over Head Valve Engine) in which a cylinder center axis is slanted. The engine 24 is a so called Atkinson cycle engine, i.e., an engine in which a valve closure timing of an inlet valve 94 (to be described later) is after the bottom dead center. The engine 24 preferably has a geometric compression ratio not smaller than about 8.5, for example. The engine 24 includes a cylinder 54. The cylinder 54 includes a cylinder body 56 and a cylinder head 58 which is attached to an upper end portion of the cylinder body 56. A cylinder head cover 60 is attached to an upper end portion of the cylinder head 58. A crank case 62 is provided in a lower portion of the cylinder body 56.

The cylinder body 56 includes an inner circumferential surface provided with a cylinder liner 56a. Inside the cylinder body 56, a piston 64 is provided slidably with respect to the cylinder liner 56a. The crank case 62 accommodates the crank shaft 66 and a cam shaft 68 which moves in association with the crank shaft 66. The crank shaft 66 is disposed horizontally. The crank shaft 66 and the cam shaft 68 are parallel or substantially parallel to each other. The cam shaft 68 is disposed not to interfere (contact) with crank webs 70 of the crank shaft 66. The piston 64 and the crank shaft 66 are connected to each other by a connecting rod 72, such that reciprocating movement of the piston 64 is converted into rotating movement by the crank shaft 66. The crank shaft 66 is provided with a drive gear 74, whereas the cam shaft 68 is provided with a driven gear 76 which rotates in association with rotation of the drive gear 74. The crank case 62 also accommodates a balancer 78. The balancer 78 is in engagement with a gear 80 provided in the crank shaft 66, to reduce vibration. As shown in FIG. 3, when the engine 24 is viewed from a position where the crank shaft 66 is located on the left side and the cam shaft 68 is located on the right side, rotation direction of the crank shaft 66 is counterclockwise as indicated by Arrow A.

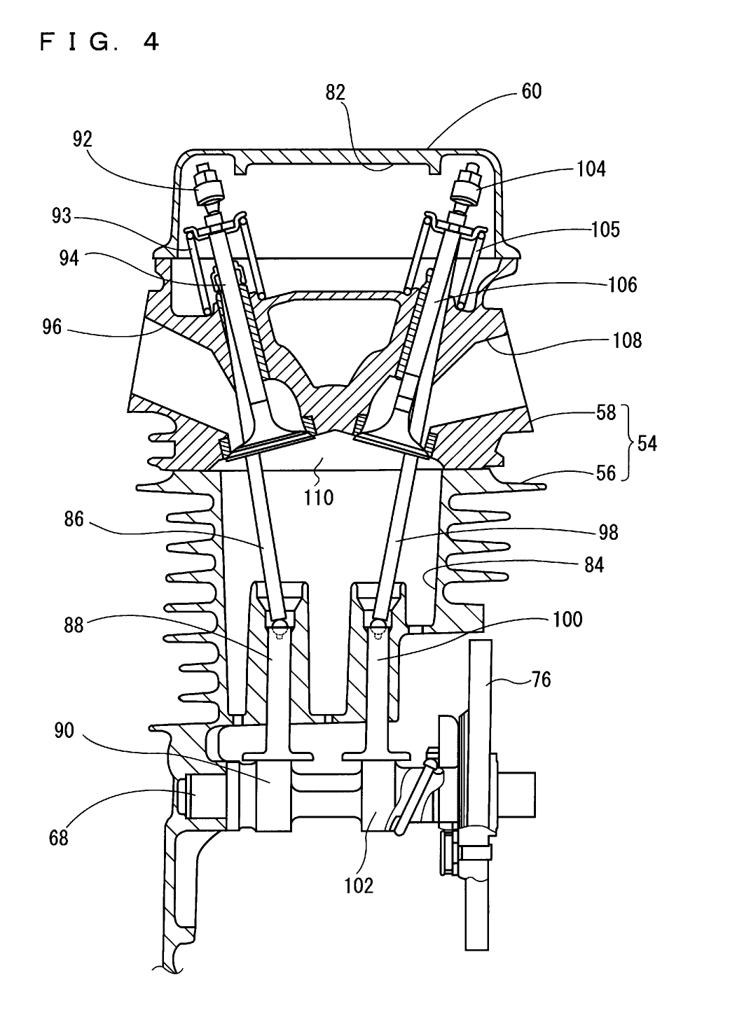

Referring also to FIG. 4, from the cylinder body 56 to the cylinder head 58, there is provided a communication path 84 configured to provide communication between inside of the crank case 62 and inside of a rocker arm chamber 82 in the cylinder head cover 60. A pushrod 86, and a tappet 88 provided on an end portion of the pushrod 86 are inserted through the communication path 84. Inside the crank case 62, the tappet 88 has its tip portion contacted to an inlet cam 90 of the cam shaft 68. The push rod 86 includes another end portion contacted to a rocker arm 92 which is provided inside the rocker arm chamber 82. The rocker arm 92 drives the inlet valve 94 which is under a constant upward urge from a valve spring 93. The inlet valve 94 opens/closes an inlet port 96. The inlet port 96 is connected to an unillustrated intake pipe. A push rod 98, and a tappet 100 which is provided at an end portion of the push rod 98 are inserted through the communication path 84. Inside the crank case 62, the tappet 100 includes a tip portion contacted to an exhaust cam 102 of the cam shaft 68. The push rod 98 includes another end portion contacted to a rocker arm 104 which is provided inside the rocker arm chamber 82. The rocker arm 104 drives an exhaust valve 106 which is under a constant upward urge from a valve spring 105. The exhaust valve 106 opens/closes an exhaust port 108. The exhaust port 108 is connected to an unillustrated exhaust pipe. As described, the engine 24 includes one inlet valve 94, one inlet port 96, one exhaust valve 106 and one exhaust port 108.

Valve opening/closure timings and valve lifts for the inlet valve 94 and the exhaust valve 106 are determined by respective profiles (sectional shapes) of the inlet cam 90 and the exhaust cam 102.

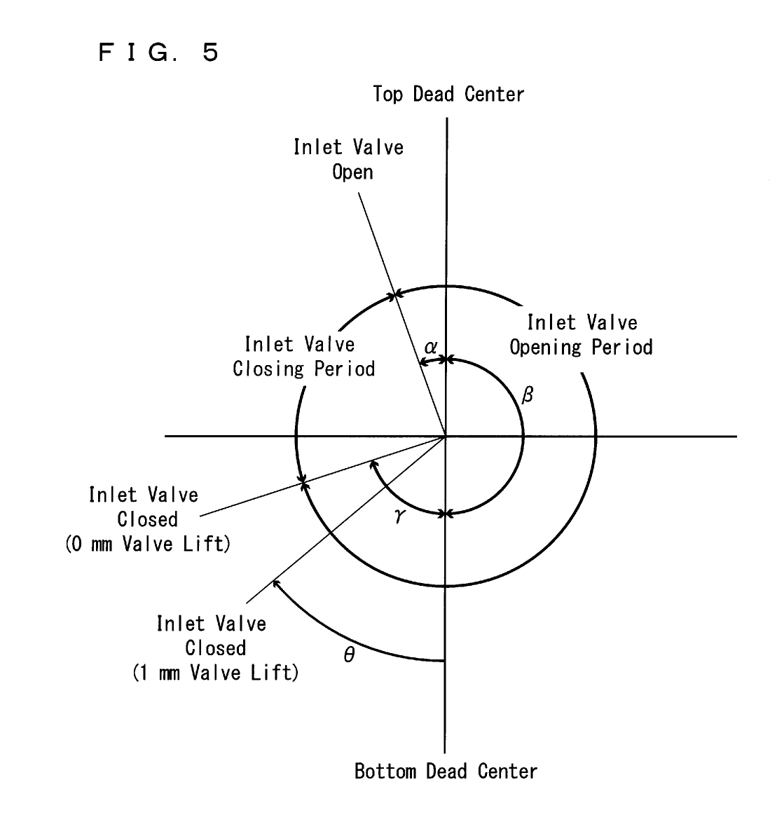

The valve opening/closure timings for the inlet valve 94 are preferably set as shown in FIG. 5. The inlet valve 94 opens slightly before the top dead center, and closes after the bottom dead center. The valve closure timing of the inlet valve 94 preferably is defined as a time when the inlet valve 94 in its closing process has a valve lift of about 1 mm, for example, and this timing is selected to be within a range from after the bottom dead center to the top dead center. Specifically, the valve closure timing (when the valve lift is about 1 mm, for example) is preferably selected from a range of 0 degree<θ<180 degrees, where θ represents a crank angle from the bottom dead center. The valve closure timing is preferably selected from a range of about 43 degrees≦θ≦about 74 degrees, for example.

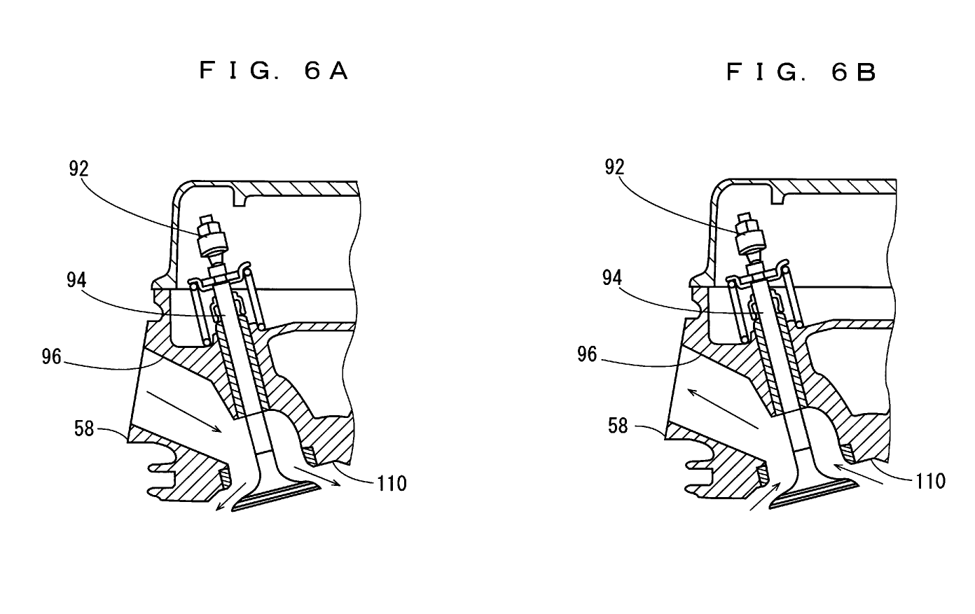

In FIG. 5, during the time when the inlet valve 94 is open, there is a period β, which is a period from the top dead center to the bottom dead center. In this period, as shown in FIG. 6A, air-fuel mixture is introduced from the inlet port 96 to a combustion chamber 110. As shown in FIG. 6B, from the time when the inlet valve 94 is opened to the time when the top dead center is reached, i.e., in a period α, and from the time when the bottom dead center is reached to the time when the inlet valve 94 is closed (valve lift becomes 0 mm), i.e., in a period γ, the air-fuel mixture is pushed back, out of the combustion chamber 110, to upstream of the inlet valve 94.

An oil dipper 112 is attached to a big end portion 72a of the connecting rod 72, and oil (not illustrated) is stored inside the crank case 62. The oil is splashed by the oil dipper 112 to the cylinder body 56, the cylinder head 58, the cylinder head cover 60 and so on, directly or indirectly after spattering on the crank shaft 66, the cam shaft 68, etc., such that lubrication of the crank shaft 66, the cam shaft 68, the cylinder body 56, the rocker arms 92, 104 etc. is achieved.

According to the engine 24 as has been described, the inlet valve 94 is open even after the bottom dead center and therefore, the air-fuel mixture which was once introduced into the combustion chamber 110 of the cylinder 54 is pushed back to the upstream of the inlet valve 94 (toward the intake pipe). For this reason, even if a geometric compression ratio is high, preferably being not smaller than about 8.5, for example, an actual compression ratio is lower than the geometric compression ratio. Consequently, the actual compression pressure is not as high as a compression pressure under the geometric compression ratio. In other words, the engine provides a high expansion ratio but the actual compression pressure does not become high. Therefore, the arrangement reduces increase in cranking torque necessary to start the engine 24 with the recoil starter 32, while improving thermal efficiency of the engine 24. Also, the air-fuel mixture is not released toward the exhaust pipe, but toward the intake pipe. Therefore, the arrangement reduces after fire. As understood, the arrangement makes it possible, while keeping a high geometric compression ratio, to significantly reduce or prevent an increase in the engine starting cranking torque, and to significantly reduce or prevent after fire as well.

Compared to a multi-cylinders engine, a single-cylinder engine has a smaller friction loss if the engine displacement is the same, because a single-cylinder engine has a smaller sliding surface area between the piston and the cylinder. Also, a single-cylinder engine has a smaller total surface area of the cylinder and the combustion chamber. Therefore, the single-cylinder engine has a smaller thermal loss and a higher thermal efficiency. In addition, it is often the case that a single-cylinder engine includes a manual starter. According to the engine 24, it is possible to reduce increase in the engine starting cranking torque even if the geometric compression ratio is high. Hence, the engine 24 is suitable for single-cylinder engine configurations.

According to the engine 24, a valve closure timing of the inlet valve 94 represented by a crank angle from the bottom dead center, preferably is selected from a range of not smaller than about 43 degrees to not greater than about 74 degrees, for example. This makes it possible to appropriately reduce the actual compression ratio, and therefore to significantly reduce or prevent an increase of engine starting cranking torque while improving thermal efficiency of the engine 24.

The inventor of the present invention discovered and took special notice of a fact that in the engine 24, which utilizes a so called Atkinson cycle where the valve closure timing of the inlet valve 94 is after the bottom dead center, and which includes only one inlet valve 94, the amount of air-fuel mixture which is pushed back to the upstream of the inlet valve 94 during the period γ in FIG. 5 varies when the number of revolutions of the engine varies. Specifically, as the number of revolutions of the engine becomes higher, fluid velocity of the air-fuel mixture becomes higher, and therefore there is a higher resistance to reversing of the flow of the air-fuel mixture to the upstream of the inlet valve 94. Simultaneously, the period from the time when the piston 64 is at the bottom dead center to the time when the inlet valve 94 is closed becomes shorter, so the air-fuel mixture becomes less prone to flow upstream of the inlet valve 94. This means that the actual compression ratio in a medium-low rotation region can be made smaller than in a high rotation region, and that the actual compression ratio in the high rotation region does not decrease as much. Hence, in cases where the engine 24 which has a single inlet valve 94 is utilized in the engine generator 10, it is possible to reduce or prevent knocking in a medium-low rotation region, such that it is possible to obtain good thermal efficiency and output in a high rotation region (range of normal engine use) of 3000 rpm through 3600 rpm, so the engine 24 can be suitably utilized for the engine generator 10.

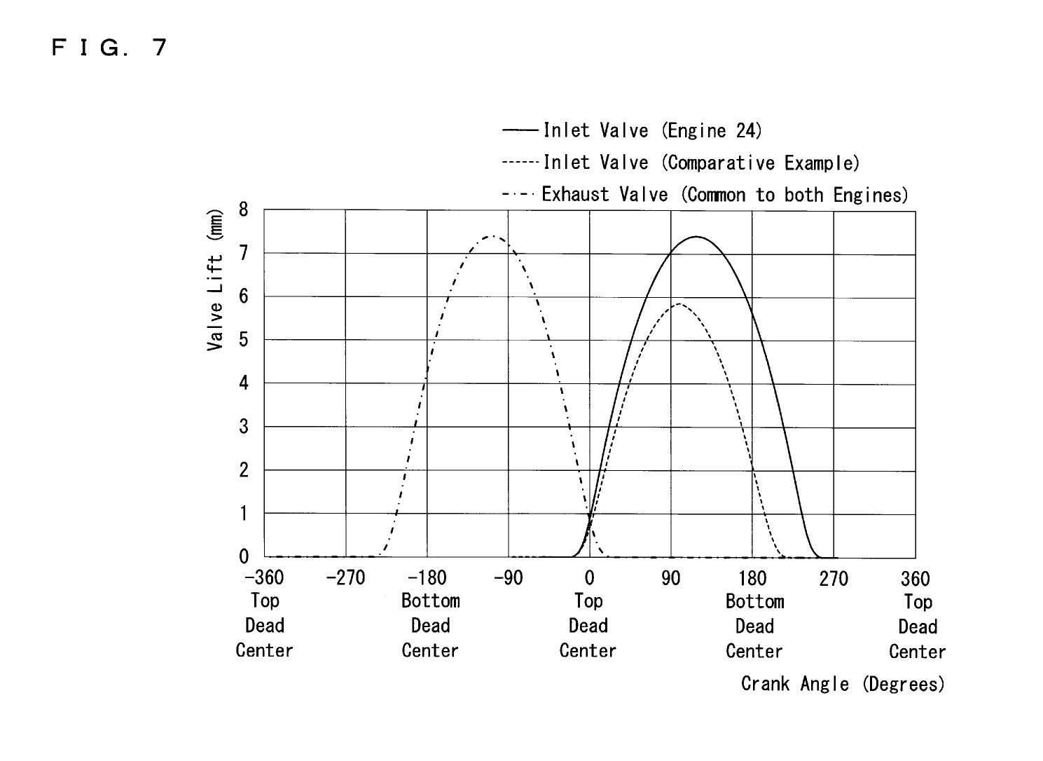

Further, reference will be made to FIG. 7 through FIG. 11, to describe an experiment in which the engine 24 according to a preferred embodiment according to the present invention was compared to a comparable engine (hereinafter called “comparative example”).

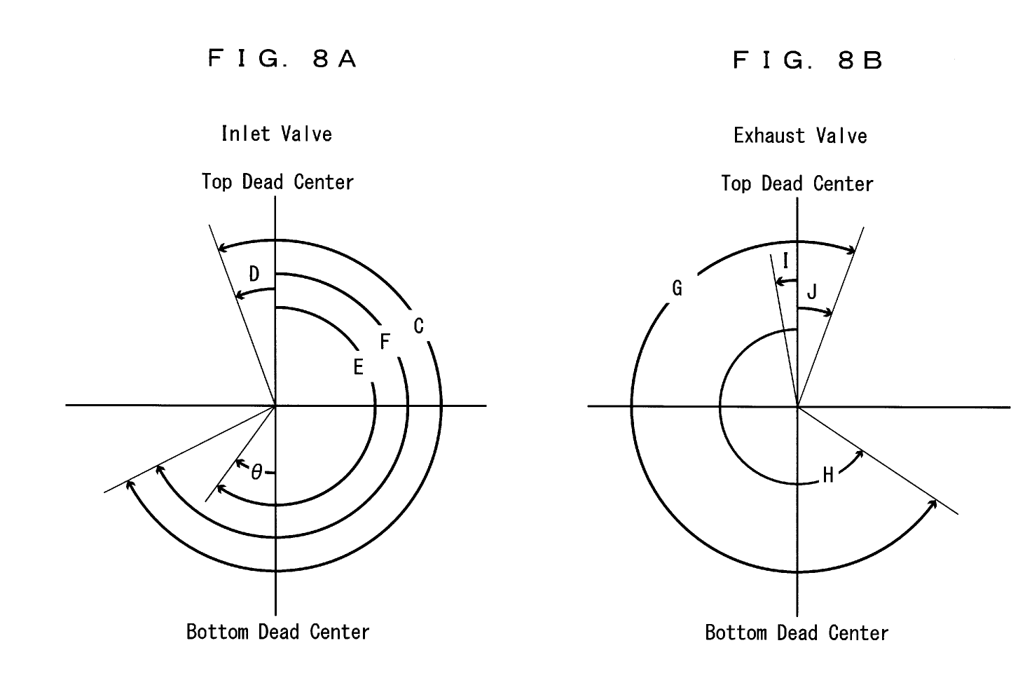

Table 1 and FIG. 7 show various settings of the engine 24 and the comparative example. FIG. 8A shows graphical representation of the periods and valve opening/closure timings for the inlet valves given in Table 1, whereas FIG. 8B shows graphical representation of the periods and valve opening/closure timings for the exhaust valves given in Table 1.

TABLE 1

| | | Compar- | |
|---|---|---|---|
| | | ative | Engine |
| | | Example | 24 |
| | Displacement (Single Cylinder): cc | 357 | 357 |
| | Geometric Compression Ratio (Expansion Ratio) | 8.1 | 8.8 |
| C | Inlet Cam Opening Degree: Period in which Inlet | 240 | 272 |
| | valve is lifted (Angle): Degrees | | |
| D | Inlet Valve Opening Timing (0 mm Valve Lift) | −20 | −20 |
| | (Crank Angle) Degrees | | |
| E | Inlet Valve Closure Timing (1 mm Valve Lift) | 194 | 230 |
| | (Crank Angle) Degrees | | |
| F | Inlet Valve Closure Timing (0 mm Valve Lift) | 220 | 252 |
| | (Crank Angle) Degrees | | |
| θ | Inlet Valve Closure Timing at 1 mm Valve Lift | 14 | 50 |
| | from Bottom Dead Center) (Crank Angle) | | |
| | Degrees | | |
| G | Exhaust Cam Opening Degree: Period in which | 256 | 256 |
| | Exhaust valve is lifted (Angle): Degrees | | |
| H | Exhaust Valve Opening Timing (0 mm Valve | −236 | −236 |
| | Lift) (Crank Angle) Degrees | | |
| I | Exhaust Valve Closure Timing (1 mm Valve | −2 | −2 |
| | Lift) (Crank Angle) Degrees | | |
| J | Exhaust Valve Closure Timing (0 mm Valve | 20 | 20 |
| | Lift) (Crank Angle) Degrees | | |

As understood from Table 1 and FIG. 7, in this experiment, the engine 24 and the comparative example are set to the same inlet valve opening timing, but to different inlet valve closure timings, namely, the engine 24 is set to a later closure timing. Therefore, the engine 24 has a greater inlet cam opening degree. Also, the engine 24 has a greater valve lift of the inlet valve. In Table 1, the valve opening/closure timings for the inlet valve and the exhaust valve are indicated by crank angles from the top dead center. For example, the valve closure timing (about 1 mm valve lift) of the inlet valve 94 in the engine 24 is about 230 degrees, which is a crank angle from the top dead center, which namely is a crank angle of about 50 degrees from the bottom dead center. All the other settings of the engine 24 and the comparative example, including the valve opening/closure timings for the respective exhaust valves, are identical between the two.

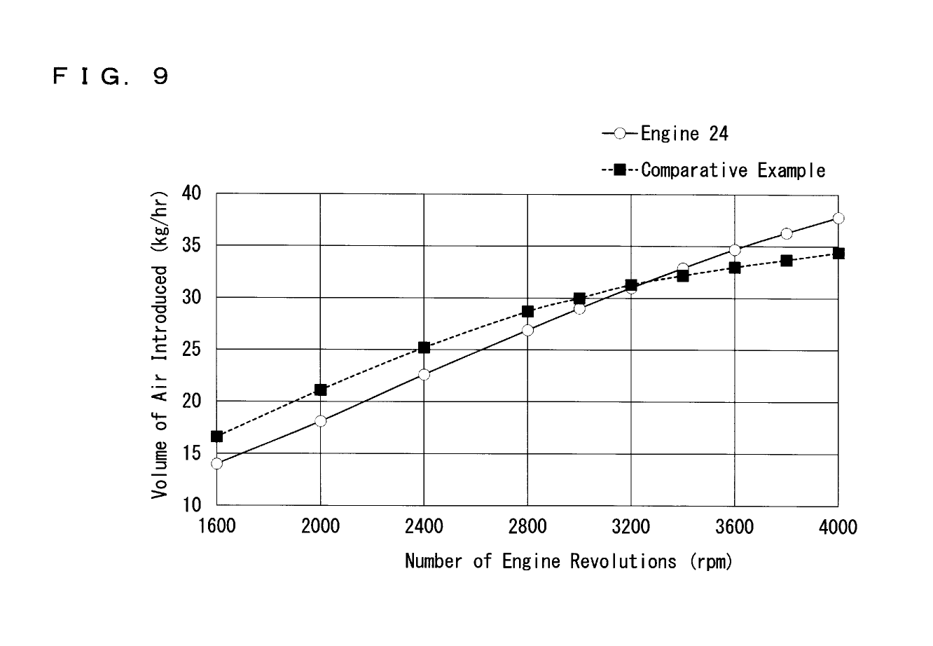

By using air instead of air-fuel mixture, an experiment was performed to determine how much volume of air introduced is inside the cylinder 54 when the inlet valve 94 is closed (0 mm valve lift). Results are shown in FIG. 9. Referring to FIG. 9, as the number of revolutions of the engine increases, the volume of air introduced increases because air becomes less prone to flow back to the upstream of the inlet valve 94. In comparison of the two engines in terms of the volume of air introduced, the engine 24, in which the inlet valve 94 closes later than in the comparative example, shows smaller volumes in the medium-low rotation region of the number of engine revolutions. However, the situation is reversed at approximately 3200 rpm, and in the higher rotation region, the engine 24 which has a higher geometric compression ratio shows greater volumes of air than the comparative example. The amount of air-fuel mixture introduced behaves similarly to the amount of air introduced. Therefore, the engine 24 takes smaller volumes of air-fuel mixture than the comparative example in the medium-low rotation region of the number of engine revolutions, but the situation is reversed at approximately 3200 rpm, and in the higher rotation region, the engine 24 takes greater volumes than the comparative example.

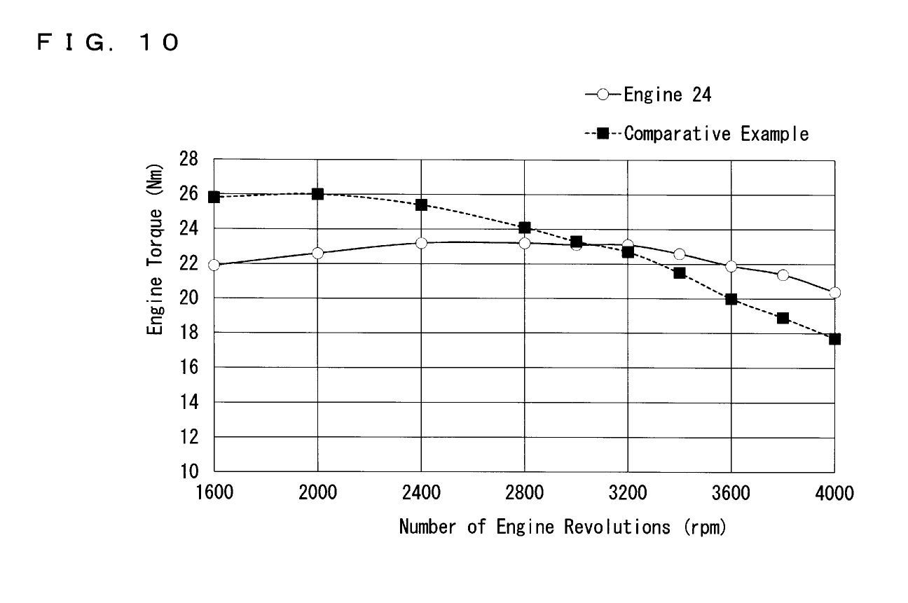

Referring to FIG. 10 which shows engine torque comparison, like FIG. 9, the engine 24 generates lower torques than the comparative example in the medium-low rotation region of the number of engine revolutions, but the situation is reversed at approximately 3000 rpm, and in the higher rotation region, the engine 24 generates higher torques than the comparative example.

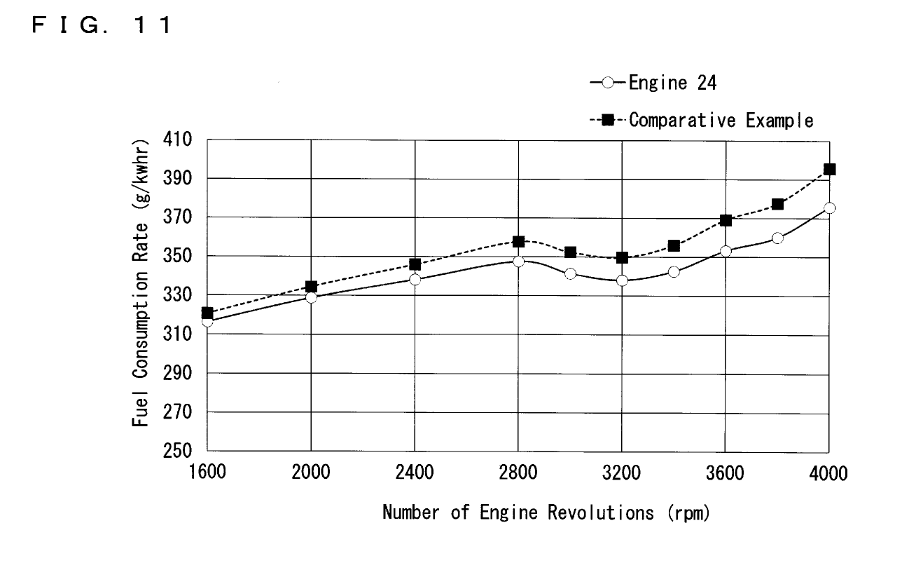

With reference to FIG. 11, fuel consumption rate will be compared. Throughout the entire range from the medium-low rotation region to the high rotation region of the number of engine revolutions, the engine 24 has a lower fuel consumption rate than the comparative example, with a larger difference between the two as the engine rotation region goes higher. As understood, the engine 24 has a better fuel economy than the comparative example.

As is clear from these results of experiments, according to the engine 24, air-fuel mixture becomes less prone to flow back to the upstream of the inlet valve 94 at a higher number of revolutions of the engine, so it is possible to make an actual compression ratio smaller in the medium-low rotation region than in the high rotation region, without much decrease in the actual compression ratio in the high rotation region. Therefore, it is possible to reduce knocking in the medium-low rotation region while obtaining good thermal efficiency (fuel economy) and output (torque) in the high rotation region.

In the preferred embodiment described above, description was made for a case where the fuel preferably is gasoline, for example. However, the fuel may be gaseous fuel such as a fuel gas. Gaseous fuels such as a fuel gas typically have smaller Lower Heating Values, and therefore tend to produce lower output than liquid fuels such as gasoline if engine displacement is the same. For improved output, increasing the compression ratio is a key, but like in liquid-fuel engines, this often leads to a problem of abnormal combustion, like knocking. Since the engine 24 is capable of maintaining a high output while reducing abnormal combustion, the engine 24 is suitably applicable to gas-fuel engines.

The manual starter is not limited to a recoil starter, and may be provided by a kick starter.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A four-cycle engine comprising:
a cylinder;
one inlet port configured to supply an air-fuel mixture into the cylinder;
one inlet valve configured to open and close the inlet port;
a piston configured to reciprocate inside the cylinder;
a crank shaft configured to convert reciprocating movement of the piston into rotating movement;
a connecting rod configured to connect the piston and the crank shaft to each other; and
a manual starter configured to rotate the crank shaft; wherein
the engine has a geometric compression ratio not smaller than about 8.5; and
the inlet valve has a valve closure timing within a range from after a bottom dead center to a top dead center, with the inlet valve closure timing being defined as a moment when the inlet valve in its closing stroke has a valve lift of about 1 mm.

2. The four-cycle engine according to claim 1, wherein the four-cycle engine is a single-cylinder engine.

3. The four-cycle engine according to claim 2, wherein the valve closure timing of the inlet valve is within a range of not smaller than about 43 degrees to not greater than about 74 degrees, in terms of a crank angle from the bottom dead center.

4. The four-cycle engine according to claim 3, wherein the four-cycle engine is a gas-fuel engine configured to utilize a gaseous fuel.

5. An engine generator comprising the four-cycle engine according to claim 1.
